(19) United States
(12) Patent Application Publication
(10) Pub. No.: US 2019/0116717 A1
(43) Pub. Date: Apr. 25, 2019

(54) METHOD AND DEVICE FOR OPERATING AN AGRICULTURAL MACHINE

(71) Applicant: Kverneland Group Kerteminde AS, Kerteminde (DK)

(72) Inventors: Marco Pauli, Steisslingen (DE); Manuel Leute, Donaueschingen (DE)

(21) Appl. No.: 16/306,567

(22) PCT Filed: May 31, 2017
(86) PCT No.: PCT/EP2017/063110

§ 371 Date: Dec. 1, 2018

(30) Foreign Application Priority Data
Jun. 3, 2016 (EP) 16172934.8

(51) Int. Cl. A01B 63/00; A01B 63/28; A01B 63/02; A01D 34/00; A01D 78/10

(52) U.S. Cl. CPC A01B 63/008; A01B 63/28; A01D 78/1085; A01D 34/006; A01D 78/1028; A01B 63/02

(57) ABSTRACT

The invention relates to a method (100) for operating an agricultural machine (1, 201) on a useful agricultural area (4, 5), comprising a traction vehicle (2) and a working appliance combination (3, 203) connected to the traction vehicle (2) in the form of a mower and/or rake, the harvest goods being processed with a plurality of working devices (33a-33d, 233a-233c), which are arranged so as to project from a carrying frame (31, 231a-231b) transversely with respect to the direction of travel (F) of the working device combination (3, 203), wherein the working appliances (33a-33d, 233a-233c) can each be raised and lowered independently of one another in order to move the working appliances either into a headland position or into engagement with the harvest goods, characterized in that when processing by means of a preferably satellite-assisted navigation system (21), position data of the working device combination (3, 203) is acquired continuously and, from the same, at least one already processed field area (41, 51) is determined and recorded (112), and in that the working devices (33a-33d, 233a-233c) are each raised automatically (113) on the basis of their positions when reaching the at least one already processed field area (41, 15) again, and/or in that the working devices (33a-33d, 233a-233c) are each automatically lowered (114) on the basis of their positions when moving out of the at least one already processed field area (41, 51 into a field area (42, 52) that is still to be processed.

The invention relates to a method for operating an agricultural machine, having the features of the preamble of claim 1, an agricultural machine, having the features of the preamble of claim 13, and a machine control for an agricultural machine, having the features of the preamble of claim 14.

When harvesting fodder crop, it is common to process the crop (such as grass) using an agricultural machine by means of an implement combination in the form of a mower and/or swather. The crop is first mown and then deposited on the agricultural useful area as a windrow by the swather, before it is picked up by, for example, a self-loading trailer and transported away. Usually, the agricultural machine, consisting of a tractor vehicle and an implement combination, connected therewith, in the form of the mower or swather is used, comprising a support frame with a number of implements, protruding therefrom transverse to the direction of travel or arranged on the front side or rear side of the tractor vehicle. Such implements may be, for example, mowing bars and/or rotary rakes. For example, the rotary rakes are each formed of a rotary head and a number of tine arms arranged circumferentially thereof, from the ends of each of which a number of tines project toward the ground. Due to the rotational movement of the rotary rake, the crop distributed over the agricultural useful area crop is raked together to form a windrow.

Typically, in such implement combinations, the implements can each be independently lifted and lowered to bring them either into a headland position or in engagement with the crop. This makes it possible to either lower the implements for working or, in a field area already worked, for example in the headland, to raise them to the headland position, so that the windrow already deposited there is not affected.

From EP 2 547 188 B1, for example, a hay harvesting device is known in which two harvesting implements are automatically brought into the headland position or into engagement with the crop, depending on the device speed as well as an angle between the direction of travel and a boundary line. The boundary line is either detected by a camera or taken from the field map of a GPS system.

A disadvantage of the known device is that the real situation on the agricultural useful area does not always correspond accurately enough with the existing field map of the GPS system. This results in inaccurate work and associated crop losses.

The object of the present invention is therefore to provide a method and a device for operating an agricultural machine, having a tractor vehicle and an implement combination connected with the tractor vehicle in the form of a mower and/or swather, resulting in reduced crop losses.

To achieve this object, the invention provides a method for operating an agricultural machine, having the features of claim 1.

Advantageous embodiments of the invention are named in the dependent claims.

By continuously capturing position data of the implement combination with a preferably satellite-supported navigation system during working, the distance travelled on the agricultural useful area during the working is known. In addition, since the arrangement of the implements as an implement combination on the tractor vehicle is known a priori, the field area already worked can be determined and recorded from the position data. Consequently, during operation of the implement combination, the worked field area is determined particularly accurately and independently of existing map resources.

The fact that the implements are each independently raised or lowered based on their positions when the at least one field area already worked is reached again and/or when entering from the field area already worked into a field area still to be worked means that the working of the crop is particularly precise. In addition, worked expanses in the field area already worked are not reworked and thus not affected. Consequently, there is less crop loss during working the agricultural useful area.

The method can run as a computer program in a machine control for the agricultural machine.

The tractor vehicle may be a tractor or a hauler. Typically, the tractor vehicle comprises a vehicle frame on which a motor with a gearbox is arranged, by which a number of wheels are driven to move the implement combination. Further, the tractor vehicle may have a cab for an operator in which a number of control elements are arranged for controlling the tractor vehicle and/or the implement combination. In addition, the tractor vehicle may have steered wheels, which are preferably manually steerable by means of a steering wheel in the cab and/or automatically by means of the machine control. The machine control may be arranged in the tractor vehicle. In addition, the tractor vehicle may have a hitch device for attaching a rear implement combination and a power take-off shaft for transferring a drive force to the implement combination. For example, the implements can be set into a rotational movement by the drive force for working the crop, for example for raking together by means of rotary rakes or for mowing with mowing discs. Further, the tractor vehicle may have control lines to the implement combination in order to raise and/or lower the implements.

The direction of travel of the implement combination may be the direction in which the implement combination is moved by the tractor vehicle during working. The fact that the implement combination is “connected” to the tractor vehicle may mean here that the implement combination is hitched to the tractor vehicle. Likewise, it may mean that the implement combination is connected to the tractor vehicle by the hitch device on the front, back and/or side.

The implement combination may be or comprise a mower for mowing and/or a swather for raking the crop together. The implements may be or comprise mowing discs, mowing bars, on which mowing discs are preferably arranged, and/or rotary rakes. “Working the crop” herein may mean mowing and/or raking together of the crop.

The implement combination in the form of a mower may comprise a side, front and/or rear mower as implements. The side, front and/or rear mower may each be a mowing bar, which projects from the front, side or rear of the tractor vehicle. On a side mower, two mowing bars may be arranged protruding laterally from the tractor vehicle. The mowing discs may rotate about their respective axes for mowing the crop and/or have circumferentially arranged blades. The support frame of the mower may be arranged at the front, side and/or rear of the tractor vehicle, preferably by means of the hitch device. The support frame may consist of a number of separate units, which each are arranged on the front, side, and/or rear of the tractor vehicle by means of individual hitch devices and which are connected to one another by means of the tractor vehicle. The mower may also have windrowing devices to deposit the crop in a windrow on the agricultural useful area, directly after mowing with the mowing discs.

A number of rotary rakes may be arranged on the swather in pairs, with the rotary rakes in a pair rotating in opposite directions, so that the crop is deposited between the two as a windrow or cascade-fed to a subsequent, narrower pair of rotary rakes. For example, a first pair of rotary rakes with a wider span may be arranged on the support frame, which feeds the crop to a subsequent second pair of rotary rakes with a smaller span. The second pair of rotary rakes then deposits the crop in a windrow on the agricultural useful area. The rotary rakes may each comprise a rotatable rotary head with circumferentially arranged tine arms, from the outer ends of which a number of tines each project towards the ground and are in engagement with the crop during the working. It is also conceivable that further rotary rakes, which are not automatically raised or lowered, are arranged on the swather. The support frame may extend in the swather substantially along the direction of travel and/or be supported by means of wheels on the agricultural useful area.

The implement combination may comprise the support frame on which the implements are arranged protruding, transversely to the direction of travel. For a front, side and/or rear mower, “the implements are arranged protruding from the support frame, transversely to the direction of travel of the implement combination” may mean that a mowing bar is arranged to project transversely to the direction of travel. For lifting and lowering, the implements may be connected with the support frame by means of displaceable and/or pivotable arms. It is conceivable that the implements, in addition to the lifting and lowering, may also be displaceable transversely at a distance from the support frame, for example, to adjust the working width of the implement combination. Preferably, length-adjustable arms are provided on the support frame for this purpose. Preferably, the arms may be adjustable by means of hydraulic drives. The arms may each be arranged substantially protruding from the support frame, transversely in the direction of travel. The implement combination may be connected to the tractor vehicle via control lines, such as hydraulic lines, to raise or lower the implements for example by means of hydraulic cylinders. The “implements being able to be independently lifted and lowered” may mean herein that the movement of the implements can be individually raised and lowered by the tractor vehicle and/or by the machine control by means of the pivotable arms by control lines.

In the headland position, the respective implement is moved so far upwards that the cutting discs of the mower or the tines of the rotary rake are not in engagement with the crop. The “headland position” may be a raised position of the implements, which is adopted in the so-called headland and in which the implement combination is turned during working of the agricultural useful area. Conversely, the implements can be lowered to a working position when engaging with the crop, in particular wherein the mower discs of the mower and/or the mowing bar of the mower and/or the tines of the rotary rake are at least partially in engagement with the crop and/or rotational axes of the implements are substantially perpendicular to the ground.

The navigation system may be satellite-supported, preferably designed as a GPS system. As a result, the position of the implement combination can be recorded particularly easily and accurately. The navigation system may be connected with the machine control via a data interface for transmitting the position data. The position data may comprise a list of positions of the implement combination on the agricultural useful area that have been followed during the working of the worked field area. The positions can each be coordinates or vectors. The satellite-supported navigation system may preferably be arranged on the tractor vehicle and be connected to the machine control for calculating the position data of the implement combination. The field area already worked may be the part of the agricultural useful area on which the crop has already been deposited in a windrow or a number of windrows by the implement combination.

A covered travel distance of the implement combination may be determined from the continuously recorded position data of the navigation system to determine the at least one worked field area. For example, the position data may be combined into a curve that corresponds to the covered travel distance on the agricultural useful area.

“Positions of the implements” may mean their respective position on the agricultural useful area and/or with respect to the field area already worked and/or with respect to the field area still to be worked. The respective position of an implement can be determined by means of the navigation system, wherein the relative position of the implement with respect to the navigation system, a reference point on the implement combination and/or the tractor vehicle is preferably taken into account. The positions of the implements and/or the reference point on the implement combination or on the tractor vehicle may each be stored as a coordinate or vector, preferably in the machine control.

Prior to working, a working width may preferably be defined by an operator on the basis of which a distance is set of at least one of the implements relative to the support frame and/or the front, side, and/or rear mower relative to the tractor vehicle, wherein the at least one field area already worked is determined from the working width and the covered travel distance. As a result, the field area already worked is determined particularly easily on the basis of the position data and the set working width, without requiring a field map. It is also conceivable that the working width is specified by an assistance system. The working width may correspond to the distance of the implement pair set widest transversely to the direction of travel, in particular the widest distance between two mowing bars or a pair of rotary rakes. In other words, the working width may be the width with which the crop is worked in one cycle transversely to the direction of travel of the implement combination. To calculate the field area already worked, the working width may be integrated or added up along the covered travel distance. Typically, the working width is perpendicular to the direction of travel and thus the covered travel distance.

When working, an outer field area may be worked first, which forms the field area already worked, and subsequently an inner field area, which is at least partially enclosed by the outer field area and which forms the field area still to be worked, may then be worked. As a result, the headland, in which the agricultural machine can turn particularly easily, is formed with the outer field area. In other words, the outer field area may comprise the headland. The inner field area may be partially or completely enclosed by the outer field area. Preferably, the inner field area can then be travelled in mutually parallel working lanes. This makes the fieldwork particularly efficient.

In the case of an implement combination in the form of a swather, when reaching a working limit perpendicular to the direction of travel, two rotary rakes, arranged opposite in pairs on the support frame, may be automatically raised or lowered simultaneously. In other words, the two rotary rakes, arranged opposite in pairs on the support frame simultaneously reach the working limit and are simultaneously raised or lowered. In the case of an implement combination in the form of a mower, when reaching a working limit perpendicular to the direction of travel, two mowing bars, arranged opposite in pairs on respective support frames, or a side mowing bar in combination with a rear or front mower bar can be automatically raised or lowered simultaneously. In other words, the two mowing bars, arranged opposite in pairs on the support frame, or a side mowing bar in combination with a rear or front mowing bar simultaneously reach the working limit and are simultaneously raised or lowered. The working limit may be a boundary between a field area currently being worked and the field area already worked. In other words, there may be a field area still to be worked immediately in front of the implement combination in the direction of travel, followed by the field area already worked. The working limit is formed between the two.

When reaching a working limit that is inclined relative to the direction of travel, two implements, arranged opposite in pairs on the support frame, may be automatically raised or lowered, on the basis of a calculation of position specifications of the implements with respect to the working limit, in particular wherein the implement closer to the working limit is raised or lowered first, followed by the implement further away from the working limit. As a result, the work behaviour of the implement combination is adapted to the oblique working limit and the agricultural area is worked particularly precisely.

In the case of a swather, when reaching a working limit that is inclined relative to the direction of travel, two rotary rakes, arranged opposite in pairs on the support frame, may be automatically raised or lowered, on the basis of a calculation of position specifications of the rotary rakes with respect to the working limit, in particular wherein the rotary rake closer to the working limit is raised or lowered first, followed by the rotary rake further away from the working limit. As a result, the raking behaviour of the swather is adapted to the oblique working limit and the agricultural area is worked particularly precisely.

In the case of a mower combination, when reaching a working limit that is inclined relative to the direction of travel, two mowing bars, each arranged opposite in pairs on the support frame, or a side mowing bar in combination with a rear or front mowing bar, may be automatically raised or lowered, on the basis of a calculation of position specifications of the mowing bars with respect to the working limit, in particular wherein the mowing bar closer to the working limit is raised or lowered first, followed by the mowing bar further away from the working limit. As a result, the work result is adapted to the oblique working limit and the agricultural area is worked particularly precisely.

Preferably, the automatic lifting and lowering of the implements of a pair is offset when reaching the oblique working limit. It is also conceivable that, in the case of a swather, another pair of rotary rakes are arranged successively on the support frame and are likewise raised or lowered according to the previously described procedure.

The position information may comprise a coordinate and/or a vector for each of the implements, representing the position of the implement on the implement combination in the working position. The coordinate and/or the vector may be predetermined with respect to a coordinate system and/or vector space on the tractor vehicle or on the implement combination. The position information may also be dynamically calculated on the basis of a current machine position of the tractor vehicle and/or the implement combination. For example, when the implement combination is not aligned with the tractor vehicle when cornering but instead forms an angle. As a result, the implements can be raised and lowered precisely with respect to the working limit even when cornering.

In an embodiment, the crop may be raked together with at least four implements, formed as rotary rakes, arranged opposite in pairs on the support frame, wherein a first pair of rotary rakes is arranged on the support frame further forward in the direction of travel relative to a second pair of rotary rakes, preferably wherein the first pair of rotary rakes is spaced apart wider than the second pair of rotary rakes. This allows a wider field area to be worked. When the at least one field area already worked is reached again, at least one rotary rake of the first pair and then at least one rotary rake of the second pair is raised and/or wherein at least one rotary rake of the first pair and then at least one rotary rake of the second pair is lowered when moving into the field area still to be worked.

When the field area already worked is reached again, a first distance may be taken into account to determine how far the implements may each enter the field area already worked before being raised. As a result, a certain overlap is generated, which is covered in two work operations. This can be in an area that is next to the associated windrow during the first work. Consequently, the windrow that has already been deposited is not affected here nor is there a loss of non-raked crop.

When entering from the at least one field area already worked into the field area still to be worked, a second distance can be taken into account to determine the extent to which the implements may each remain in the field area already worked while already being lowered. As a result, the implements are lowered even before entering the field area still to be worked, whereby less crop is lost. This will also create a work overlap.

When determining and recording the worked field area and/or when lifting and/or lowering the implements, a position of the implement combination and/or positions of the respective implements, for example relative to the antenna of the navigation system, can be taken into account. As a result, an offset between the implement combination or the implements and the actual measuring point of the navigation system is taken into account and the fieldwork is particularly accurate. It is also conceivable that a reference point on the implement combination relative to the antenna of the navigation system serves as a reference point for the position data. Likewise, the position of the respective implements relative to the reference point on the implement combination can be taken into account. These are usually known from design data of the implement combination. This makes the calculation of the individual positions of the implements particularly accurate.

Moreover, the invention provides an agricultural machine, having the features of claim 13, and a machine control, having the features of claim 14.

Due to the fact that the machine control, on the one hand, captures the position data of the navigation system, from which the field area already worked is determined and recorded, and, on the other hand, based thereupon, the implements, when the field area already worked is reached again or when entering from the at least one field area already worked into field area still to be worked, are automatically raised or lowered, the agricultural useful area is worked particularly accurately. At the same time, the windrow already deposited in the worked field area is not worked again or affected. Consequently, the agricultural machine according to the invention works particularly effectively and particularly little crop is lost.

The agricultural machine, consisting of the tractor vehicle and the implement combination connected therewith, and/or the machine control may each comprise the features described above with regard to the method for operating an agricultural machine individually or in any combination.

Alternatively or additionally, the agricultural machine and/or the machine control may be configured to carry out the method described above for operating an agricultural machine, preferably according to any one of the claims 1-12.

The machine control may comprise a CPU, a memory, an input unit, an output unit, and/or interfaces. The interfaces may be electrical, pneumatic, and/or hydraulic control lines. The machine control may be arranged either on the tractor vehicle or on the connected implement combination.

The aforementioned positions, position information, curves, work boundaries, the agricultural useful area and/or the field areas may be at least partially stored as a mathematical representation in a common coordinate system and/or vector space of the agricultural machine or in a number of coordinate systems and/or vector spaces, preferably in the machine control. As a result, the positions of the implements relative to the perpendicular working limit, the oblique working limit, the field area already worked and/or the field area still to be worked can be calculated particularly simply, for example vectorally.

Other features and benefits of invention are explained in further detail below on the basis of the embodiments shown in the figures. Brief description of the drawings:

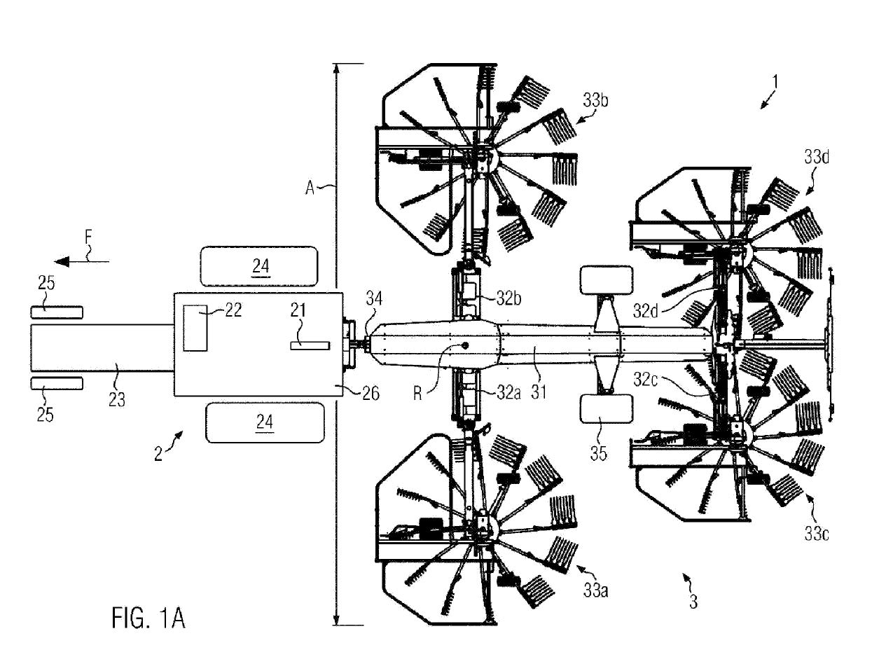

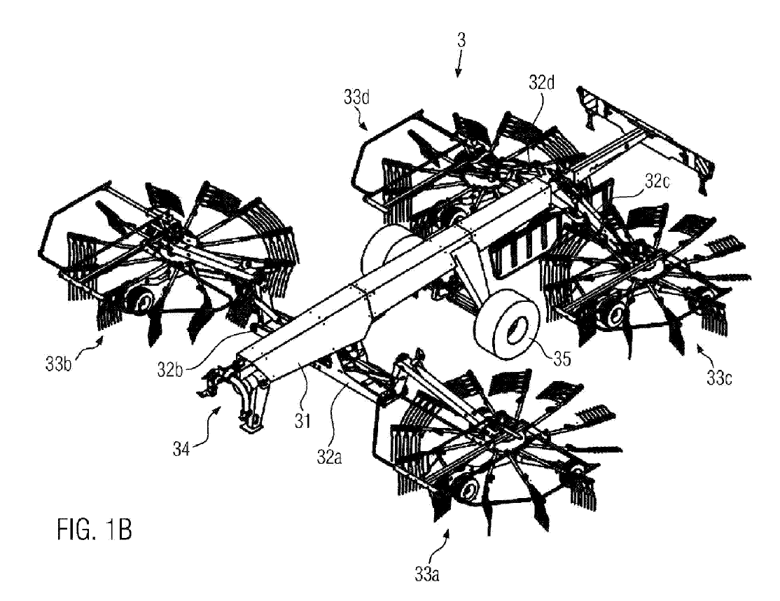

FIG. 1A-1B shows an inventive embodiment of the agricultural machine in a plan view and in a perspective view;

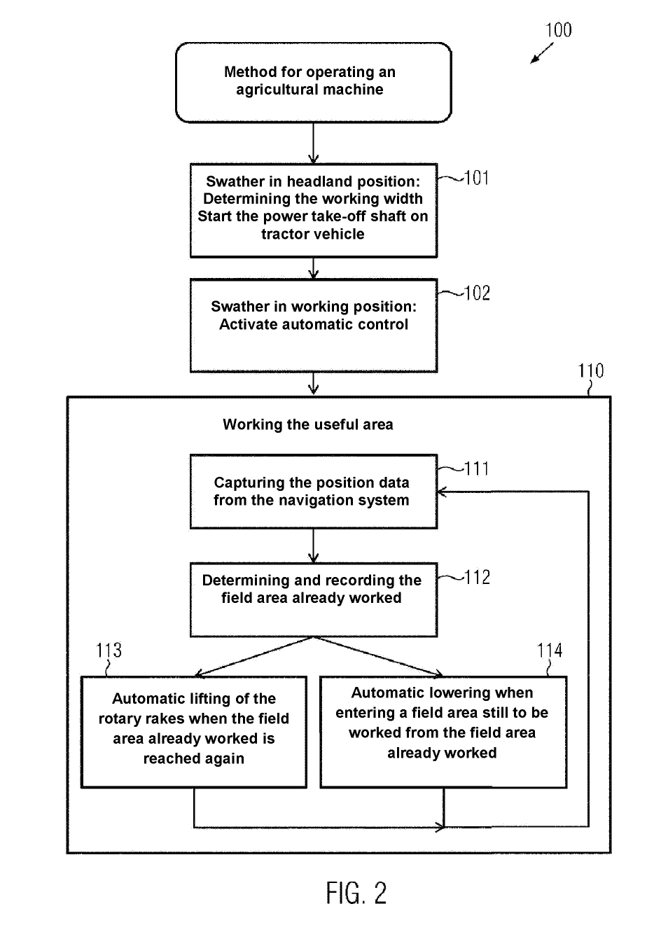

FIG. 2 shows an inventive embodiment of the method for operating the agricultural machine as a flowchart;

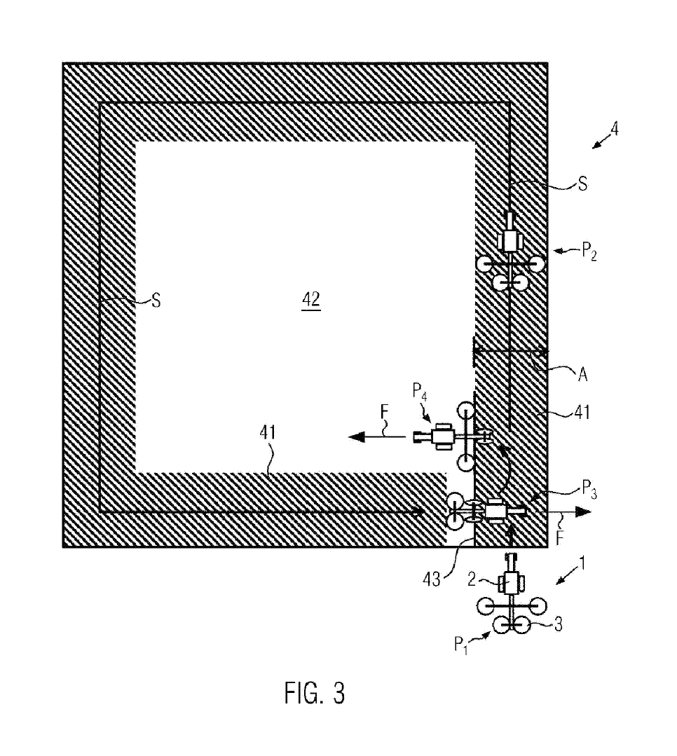

FIG. 3 shows an exemplary working of a substantially rectangular field, using the method according to FIG. 2;

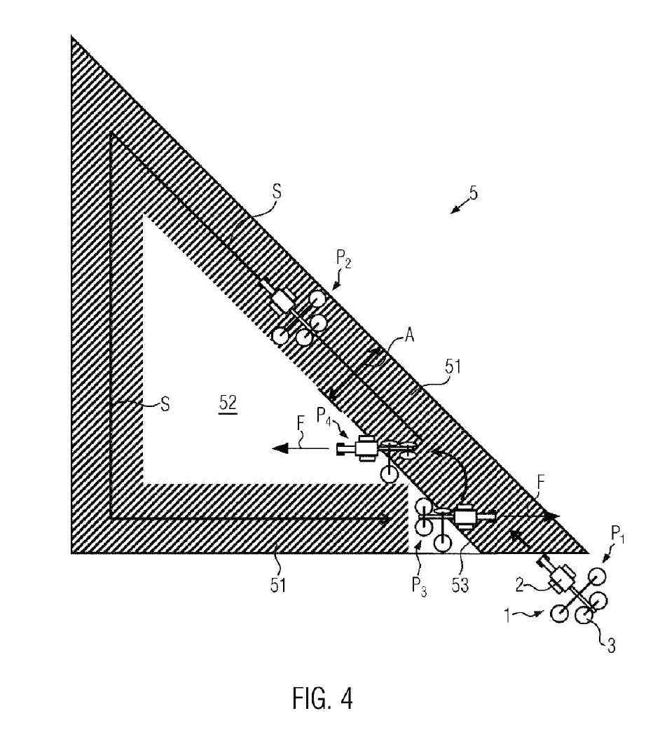

FIG. 4 shows an exemplary working of a substantially triangular field, using the method according to FIG. 2; and

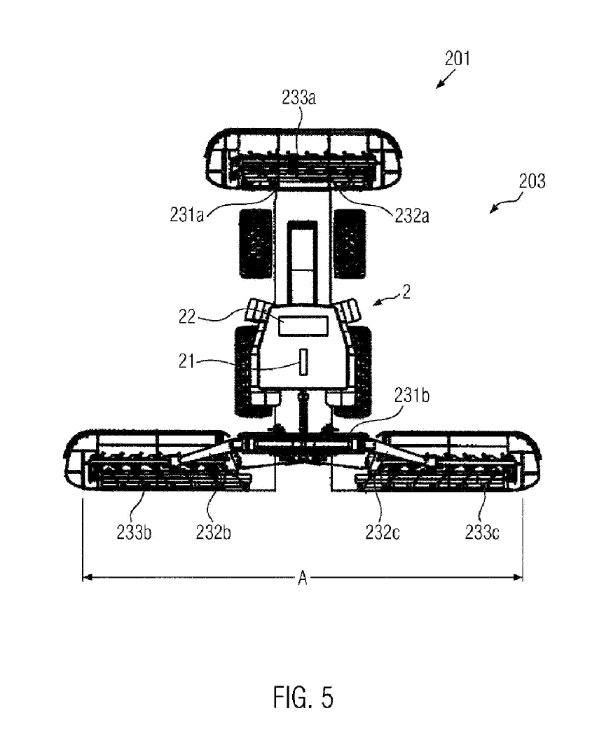

FIG. 5 shows a further embodiment of the inventive agricultural machine in a plan view.

The features described in the following exemplary embodiments of FIGS. 1A-4 are exemplified for an implement combination in the form of a swather with the implements, formed as rotary rakes 33a-33d. Likewise, instead of the swather 3, it may be an implement combination in the form of a mower, formed with mowing bars and/or mower discs as implements instead of the rotary rakes 33a-33d. The mower discs may be arranged on the mowing bar. The mower may comprise a front, side, and/or rear mower arranged at the front, side, and/or rear of the tractor vehicle 2 by means of a corresponding hitch device. It is therefore understood that the features described below with reference to FIGS. 1A-4, individually or in any desired combinations, also apply mutatis mutandis to an implement combination in the form of a mower 203, which is illustrated as an exemplary embodiment in FIG. 5.

FIG. 1A shows an agricultural machine 1 with the tractor vehicle 2 and the hitched swather 3 in a plan view. A perspective view of the swather 3 is shown in FIG. 1B.

It shows an agricultural tractor commonly used as the tractor vehicle 2. It comprises a vehicle frame 23, having an engine and transmission, two wheels 24 driven thereby, and two steerable wheels 25. An operator may be seated in the cabin 26 to steer the tractor vehicle 2.

In addition, the machine control 22 is shown, formed with a CPU, memory, various interfaces, as well as a control unit and a display. The machine control 22 is connected with the swather 3 via an interface and/or control lines, not shown here, to automatically raise or lower the rotary rakes 33a-33d independently of one another. Furthermore, the machine control 22 is also connected to the navigation system 21 via a data interface for transmitting the position data. In addition, the operator can set parameters for fieldwork on the machine control 22. This includes setting the working width A of the swather 3.

In addition, the navigation system 21 is arranged on the tractor vehicle 2, which is formed here, for example, as a GPS system. It comprises an antenna on the roof of the cab 26 of the tractor vehicle 2 in order to enable the best possible satellite reception. An electronic unit for calculating the position data is also part of the navigation system 21. By means of the same, the signals of the satellites received by the antenna are evaluated, so that the position of the tractor vehicle 2 can be accurately calculated and transmitted to the machine control 22.

The support frame 31 of the swather 3 is attached to the tractor vehicle 2 by means of the hitch device 34 and is pulled by the same. In addition, the support frame 31 is supported by the wheels 35 on the ground between the first pair of rotary rakes 33a, 33b and the second pair of rotary rakes 33c, 33d. The power take-off shaft connection for transmitting the drive force, as well as hydraulic, electrical, and/or pneumatic connections are combined with the hitch device 34. It can also be seen that the rotary rakes 33a-33d are each connected to the support frame 31 by means of arms 32a-32d. The arms 32a-32d can each be raised and lowered independently of one another. For this purpose, hydraulic or electrical control signals are transmitted from the tractor vehicle 2 to respective actuators, mounted on the arms 32a-32d, whereby the rotary rakes 33a-33d can be pivoted into the headland position or into engagement with the crop. For example, in FIG. 1B, all rotary rakes 33a-33d are shown in engagement with the crop (so-called working position). For the headland position, the rotary rakes 33a-33d are raised accordingly.

In addition, the working width A can be set separately on the rotary rakes 33a, 33b of the first pair (front pair). As a result, an asymmetrical arrangement of the rotary rakes 33a, 33b is conceivable with respect to the support frame 31. The width of the rotary rakes 33c, 33d of the second pair can be set together. This will change the windrow width. Using the first pair of rotary rakes 33a, 33b, the crop is first pushed together somewhat towards the centre and then deposited as a windrow by the subsequent second pair 33c, 33d.

FIG. 2 shows an embodiment of a method according to the invention for operating an agricultural machine 100 in a flowchart in more detail.

The steps 101 and 102 serve to prepare the work and should therefore be regarded as optional for the invention:

Initially, the swather 3 in step 101 is in the headland position, with which the rotary rakes 33a-33d are raised in the headland position. The working width A may then be set by an operator or by an assistance system before reaching the agricultural useful area. Then, the power take-off shaft on the tractor vehicle 2 is started either automatically or manually so that the drive force is transferred to the hitched swather 3. As a result, the rotary rakes 33a-33d then rotate.

In step 102, the swather 3 is then brought into the working position and the automatic control is activated. For example, by an input of the operator on the machine control 22.

In step 110, the agricultural useful area is then worked. For this purpose, an outer field area, which extends along the outer boundary of the agricultural useful area as a whole or a subarea, is worked first. In the process, position data is continuously retrieved by the navigation system 21 in step 111 and processed in step 112 to obtain a covered travel distance of the swather 3. As a result, the distance covered in the worked field area is then known independently of a field map. Since the working width A according to FIG. 1A is substantially perpendicular to the direction of travel F, the field area already worked can be calculated by integrating the working width A over the travel path.

In step 113, when the field area already worked is reached again, the rotary rakes 33a-33d are automatically raised, based on their positions. In addition, in step 114, when entering a field area still to be worked from a field area already worked, the rotary rakes 33a-33d are automatically lowered independently of one another based on their positions.

For example, the front rotary rakes 33a, 33b, shown in FIG. 1A, arranged opposite in pairs on the support frame 31, are raised or lowered simultaneously when reaching a vertical working limit. Somewhat later, the two rear rotary rakes 33c, 33d, also arranged opposite in pairs on the support frame 31, are then also raised or lowered simultaneously.

In contrast, upon arriving at a working limit oblique to the direction of travel F, the rotary rakes 33a-33d are each raised or lowered independently of one another, based on a calculation of position information of the rotary rakes 33a-33d with respect to a working limit. Coordinates or vectors of the rotary rakes 33a-33d relative to the reference point R shown in FIG. 1A, which are stored in the machine control 22 or which are dynamically calculated by the machine control 22 at the current machine position, are taken into account for this purpose. Since the coordinate or the vector of the reference point R relative to the navigation system 21 is also stored in the machine control 22 or is dynamically calculated by it, the positions of the rotary rakes 33a-33d relative to the oblique working limit can be determined precisely. Consequently, the rotary rakes 33a-33d can each be automatically raised or lowered individually upon reaching the working limit.

It is conceivable that, in steps 113, 114, when the field area already worked is reached again, a first distance takes into account how far the rotary rakes 33a-33d can each move into the already worked field area before they are raised. Alternatively or additionally, when entering from the at least one field area already worked into the field area still to be worked a second distance can be taken into account to determine how far each of the rotary rakes 33a-33d may still remain in the field area already worked and may already be lowered.

Steps 111-114 are continuously repeated in a loop while working the agricultural useful area.

The method of FIG. 2 is executed as a computer program in the machine control 22 of FIGS. 1A-1B.

Using the example of a substantially rectangular agricultural useful area 4, FIG. 3 shows the execution of the method from FIG. 2 with the agricultural machine 1 from FIGS. 1A-1B.

It can be seen that the agricultural machine 1 with the tractor vehicle 2 and the swather 3 at the position P₁ is about to enter the agricultural useful area 4. The swather 3 is brought into the headland position, the working width A is set, and the power take-off shaft on tractor vehicle 2 is started. The swather 3 is then brought into the working position and the automatic control is activated.

First, the agricultural machine 1 drives along the four field boundaries. The work is shown with the agricultural machine 1 at the position P₂ by way of example. As a result, the outer field area is raked together (hatched area) and thus forms the field area already worked 41. Position data of the swather 3 are continuously recorded by the navigation system and the covered travel distance S is determined therefrom. Using the working width A, the field area already worked 41 is then determined.

In position P₃, it can be seen that the swather 3 again reaches the field area already worked 41. Since the working limit 43 is substantially perpendicular to the direction of travel F, the rotary rakes of the front pair are first raised simultaneously while the rear pair continues to work. Then, the rear pair reaches the working limit 43 whereupon its rotary rakes are also raised simultaneously.

Next, the agricultural machine 1 turns to the position P₄. Since the front pair is now the first to move out of the field area already worked 41 into the field area 42 still to be worked, its rotary rakes are lowered first. As a result, they already start working the field area 42 still to be worked while the rear pair is still located in the headland position. When the rear pair of rotary rakes then enters into the field area still to be worked 42, its rotary rakes are lowered as well.

Thereafter, the field area 42 still to be worked is traversed in parallel field lanes. The agricultural machine 1 is turned in the field area already worked 41, i.e. in the headland. There, the individual rotary rakes are each automatically raised or lowered again, using the method of FIG. 2.

With reference to FIG. 4, the working of a substantially triangular agricultural useful area 5 by the method according to FIG. 2 is shown. The work differs substantially from FIG. 3 in that the working limit 53 extends obliquely to the direction of travel F due to the triangular shape of the agricultural useful area 5.

Initially, the agricultural machine 1 is in the position P1 in the headland position, wherein the working width A is set and the power take-off shaft of the tractor vehicle 2 is started. Next, the work begins along the outer field boundaries, so that the hatched, outer field area is raked together, thus forming the field area already worked 51.

Position data of the swather 3 are continuously recorded by the navigation system and the covered travel distance S is determined therefrom. Using the working width A, the field area already worked 51 is then determined.

When the field area already worked 51 is reached again, the working limit 53, unlike in FIG. 3, extends obliquely to the direction of travel F. As a result, the rotary rakes are raised independently. It can be seen that, at position P₃, the left front rotary rake is raised first, as it has reached the field area already worked 51. The opposite right rotary rake is raised later, once it also reaches the working limit 53. Independently therefrom, for the rear pair, the left rotary rake is raised first as well, followed by the right rotary rake. Depending on the configuration of the swather 3 and the course of the working limit 53 (as shown in FIG. 4), the two left rotary rakes are raised first, followed by the two right ones. However, if the working limit 53 is less oblique to the direction of travel F, the front pair is raised first, followed by the rear pair. If the working limit 53 extends in the reverse orientation, obliquely to the direction of travel, the right rotary rake of a pair is raised first, followed by the left rotary rake.

Subsequently, the agricultural machine turns to the position P₄, wherein the rotary rakes enter from the field area already worked 51 into the field area 52 still to be worked.

It can be seen that, due to the oblique course of the working limit 53, the left front rotary rake is lowered first again and begins to work first. The front right rotary rake is then lowered later, correspondingly offset, upon arriving at the working limit 53. As before explained with respect to the position P₃, the rear pair of rotary rakes is lowered as well, first on the left and then on the right. Depending on the obliqueness of the working limit 53, this happens either after the front pair or offset accordingly.

The calculation as to when the rotary rakes are each automatically raised or lowered is done in accordance with the method steps 113 and 114 described above, on the basis of position information of the rotary rake.

Subsequently, the field area 52 still to be worked is worked in parallel field lanes, with turning taking place in the outer field area. Here, the rotary rakes are then each automatically and independently raised or lowered based on their positions with respect to the field area already worked 51.

FIG. 5 shows a further embodiment of the inventive agricultural machine 201 in a plan view. It can be seen that here, instead of a swather, an implement combination in the form of a mower 203 is arranged on the tractor vehicle. The tractor vehicle 2 has the features previously described with reference to FIGS. 1A-1B. The features described above with reference to the swather 3 in FIGS. 1A-4 also apply mutatis mutandis to the mower 203.

It can be seen that a front mower 233a and two side mowers 233b, 233c are arranged on the tractor vehicle 2 as implements (butterfly arrangement). Within the working width A, the front mower 233a mows the central area and the side mowers 233b, 233c mow the two outer areas, to the right and left. It can also be seen that the front mower 233a and the two side mowers 233b, 233c each form a mowing bar with a number of mowing discs.

The support frame here is formed by a number of separate units 231a, 231b, connected to one another via the tractor vehicle 2.

Further, it can be seen that the front and side mowers 233a-233c are connected to the support frame 231a, 231b via arms 232a-232d. The arms 232a-232d can each be raised and lowered independently of one another. For this purpose, hydraulic or electrical control signals are transmitted from the tractor vehicle 2 to respective actuators, mounted on the arms 232a-232d, whereby the front and side mowers 233a-233d can be pivoted into the headland position or into engagement with the crop (mowing position). The method described above with reference to FIG. 2 can also be used mutatis mutandis in the agricultural machine 201 of FIG. 5, so that the agricultural useful area 4, 5 of FIGS. 3-4 can be worked accordingly.

Due to the fact that, in the method 100 according to the FIGS. 2-4, when raking together or mowing, the navigation system 21 continuously captures position data of the swather 3 or the mower 203, wherefrom the field area already worked 41, 51 is determined and recorded, after which the rotary rakes 33a-33d or the front and side mowers 233a-233c are automatically raised or lowered independently, based on their positions relative to the field area already worked, a windrow that has already been deposited in the worked field area 41, 51 is not raked again or affected. In addition, the rotary rakes 33a-33d or the front and side mowers 233a-233c are raised neither too early nor too late so that the crop is raked or mowed particularly precisely and with the least possible loss. Consequently, the method is particularly efficient.

This applies correspondingly to the machine control 22 or the agricultural machine 1, 201 of FIGS. 1A-1B and 5, respectively.

It is understood that features named in the embodiments described above are not limited to these specific combinations and are also possible individually or in any other combinations.

1. A method (100) for operating an agricultural machine (1, 201) on an agricultural useful area (4, 5) with a tractor vehicle (2) and an implement combination (3, 203) connected to the tractor vehicle (2) in the form of a mower and/or swather, the crop being processed with a plurality of implements (33a-33d, 233a-233c) arranged to project from a support frame (31, 231a-231b) transversely to the direction of travel (F) of the implement combination (3, 203), the implements (33a-33d, 233a-233c) each being raised and lowered independently of one another to either bring them into a headland position or into engagement with the crop,
wherein
when working with a preferably satellite-supported navigation system (21), position data of the implement combination (3, 203) are continuously recorded (111) and at least one field area (41, 51) already worked is determined therefrom and recorded (112), and
that the implements (33a-33d, 233a-233c) are each automatically raised (113) independently of one another on the basis of their positions when the at least one field area already worked (41, 51) is reached again,
and/or
that the implements (33a-33d, 233a-233c) are each automatically lowered (114) independently of one another on the basis of their positions when entering from the at least one field area (41, 51) already worked into a field area (42, 52) still to be worked.

2. The method (100) according to claim 1, wherein a covered travel distance (S) of the implement combination (3, 203) is determined from the continuously recorded position data of the navigation system (21) to determine the at least one worked field area (41, 51).

3. The method (100) according to claim 2, wherein prior to working a working width (A) is preferably defined by an operator, on the basis of which a distance of at least one of the implements (33a-33d, 233a-233c) from the support frame (31) is set, wherein the at least one field area (41, 51) already worked is determined from the working width (A) and the travel distance (S) covered.

4. The method (100) according to claim 1, wherein during working an outer field area which forms the already worked field area (41, 51) is worked first and then an inner field area is worked, which is at least partially enclosed by the outer field area and which forms the field area (42, 52) still to be worked.

5. The method (100) according to claim 1, wherein when a working limit (43) perpendicular to the direction of travel (F) is reached, two implements (33a, 33b/33c, 33d/233b, 233c) arranged opposite in pairs on the support frame (31) are automatically raised or lowered simultaneously.

6. The method (100) according to claim 1, wherein when a working limit (53) inclined relative to the direction of travel (F) is reached, two implements (33a, 33b/33c, 33d/233b, 233c) arranged opposite in pairs on the support frame (31) are automatically raised or lowered with respect to the working limit (53) on the basis of a calculation of position specifications of the implements (33a, 33b/33c, 33d/233b, 233c), in particular wherein first the implement (33a, 33c, 233b) closer to the working limit (53) is raised or lowered and then the implement (33b, 33d, 233c) further away from the working limit (53) is raised or lowered.

7. The method (100) according to claim 1, wherein the crop is raked together with at least four implements (33a-33d) constructed as rotary rakes, which are arranged in pairs opposite one another on the support frame (31), and wherein a first pair of rotary rakes (33a, 33b) is arranged further forward on the support frame (31) relative to a second pair of rotary rakes (33c, 33d) in the direction of travel (F), preferably wherein the first pair of rotary rakes (33a, 33b) projects from the support frame (31) wider than the second pair of rotary rakes (33c, 33d).

8. The method (100) according to claim 7, wherein when the at least one field area (41) already worked is reached again, at least one rotary rake (33a, 33b) of the first pair is first raised and then at least one rotary rake (33c, 33d) of the second pair is raised and/or wherein at least one rotary rake (33a, 33b) of the first pair is first lowered and then at least one rotary rake (33c, 33d) of the second pair is lowered when moving into the field area (42) still to be worked.

9. The method (100) according to claim 1, wherein when the already worked field area (41, 51) is reached again a first distance takes into account how far the implements can each move into the already worked field area (41, 51) before they are raised.

10. The method (100) according to claim 1, wherein when moving from the at least one field area (41, 51) already worked into the field area (42, 52) still to be worked a second distance takes into account how far the implements (33a-33d, 233a-233c) may still be in the field area (41, 52) already worked and are already lowered.

11. The method (100) according to claim 1, wherein a position of the implement combination (3) and/or positions of the respective implements (33a-33d) relative to the navigation system (21), preferably relative to an antenna of the navigation system (21), are taken into account when determining and recording the worked field area (41, 51) and/or when raising and/or lowering the implements (33a-33d, 233a-233c).

12. The method (100) according to claim 1, wherein the crop is processed with two, four or six implements (33a-33d, 233a-233c) arranged opposite one another in pairs on the support frame (31), each of which can be raised and lowered independently of one another.

13. An agricultural machine (1) with a tractor vehicle (2) and an implement combination (3) connected to the tractor vehicle (2) in the form of a mower or swather for processing crop on an agricultural useful area (4, 5), with a support frame (31), with a plurality of implements (33a-33d, 233a-233c) arranged to project transversely to the direction of travel (F), which can be raised and lowered independently of one another in order to bring them either into a headland position or into engagement with the crop, with a machine control (22) for controlling the raising and lowering of the implements (33a-33d, 233a-233c) and with a preferably satellite-supported navigation system (22) for recording position data of the implement combination (3),
wherein
the machine control (22) is designed
to continuously record the position data of the navigation system (21) during working and to determine and record at least one already worked field area (41, 51) therefrom, and
to control the lifting and lowering of the implements (33a-33d, 233a-233c) in such a way
that the implements (33a-33d, 233a-233c) are automatically raised independently of one another on the basis of their positions when the at least one field area (41, 51) already worked is reached again,
and/or
that the implements (33a-33d, 233a-233c) are automatically lowered independently of one another on the basis of their positions when moving from the at least one field area already worked (41, 51) into a field area (42, 52) still to be worked.

14. A machine control (22) for an agricultural machine (1) with a tractor vehicle (2) and an implement combination (3) connected to the tractor vehicle (2) in the form of a mower or swather (3) with a plurality of implements (33a-33d, 233a-233c) for processing crop on an agricultural useful area (4, 5),
wherein
the machine control (22) is designed to continuously record position data of a preferably satellite-supported navigation system (21) during working and to determine and record at least one already worked field area (41, 51) therefrom, and
to control a lifting and lowering of the implements (33a-33d, 233a-233c) in such a way
that the implements (33a-33d, 233a-233c) are automatically raised independently of one another on the basis of their positions when the at least one field area (41, 51) already worked is reached again,
and/or
that the implements (33a-33d, 233a-233c) are automatically lowered independently of one another on the basis of their positions when moving from the at least one field area (41, 51) already worked into a field area (42, 52) still to be worked.
